(19) United States
(12) Patent Application Publication
(10) Pub. No.: US 2023/0196252 A1
(43) Pub. Date: Jun. 22, 2023

(54) METHOD FOR EVALUATION OF OIL LISTS FOR ASPHALT PRODUCTION

(71) Applicant: Petróleo Brasileiro S.A. - Petrobras, Rio de Janeiro (BR)

(72) Inventors: Helton Siqueira Maciel, Rio de Janeiro (BR); Adriana Tinoco Martins, Rio de Janeiro (BR); Luis Alberto Herrmann Do Nascimento, Rio de Janeiro (BR); Arlan Lucas De Souza, Rio de Janeiro (BR)

(21) Appl. No.: 18/084,730

(22) Filed: Dec. 20, 2022

(30) Foreign Application Priority Data
Dec. 20, 2021 (BR) 10 2021 025878 0

(51) Int. Cl. G06Q 10/0639; G06Q 50/02

(52) U.S. Cl. CPC G06Q 10/06395; G06Q 50/02

(57) ABSTRACT

The present invention addresses to a predictive method that determines the favorability of a certain list of oils for the production of oil asphalt cement (OAC), according to the requirements of the Brazilian asphalt specification of the ANP. The method was developed using an artificial intelligence algorithm, based on thousands of industrial data collected, by means of queries in BI, during the OAC campaigns of the producing refineries of the system. With a very high predictive capacity, the method is able to determine the probability of a given list of oils producing asphalt, considering both the fundamental properties of the oils that compose the same, as well as operational aspects and production route, since it was calibrated with industrial data from OAC campaigns in real magnitude. Such a model can be implanted in a web application and in an electronic spreadsheet.

The application of the method of this invention allows flexibility in the allocation of oils, reduction of OAC campaign times and operating costs, in addition to providing greater reliability in the production of asphalts and being easy to use.

### FIELD OF THE INVENTION

The present invention addresses to a method of evaluating oil lists for the production of asphalts, with application in the fields of Logistics, Refining, and R&D (Research and Development), as well as can be adapted by the digital transformation area to the implementation of digital twins in the refineries, aiming at evaluating the favorability of oil lists for the production of asphalts in a simple, fast and very precise way, managing to determine the probability of the list in question of producing asphalts, simply by informing the composition of oils in the load and production route.

### DESCRIPTION OF THE STATE OF THE ART

The technique or tool hitherto used for the evaluation of oils for Oil Asphalt Cement (OAC) is based on Shell’s Heukelon diagram, from 1969, also known as Bitumen Test Data Chart (BTDC). This is an approach based on analysis of vacuum residues (VR) (penetration, viscosity and softening point), which evaluates and compares the consistency of VR (or VR mixtures) at different temperatures, indicating the suitability of the list for OAC production. The method makes it possible to classify asphalt into three classes: S (straight) –suitable for paving and with a direct consistency relationship at different temperatures according to the diagram; B (blown) –blown – still good for paving, but with consistency at high temperatures relatively greater than at intermediate temperatures, and W (waxy) – theoretically richer in waxes and paraffins, with consistency at high temperatures relatively lower than at an intermediate temperature, indicating a product not suitable for paving.

Although this technique is implemented in Brazilian refineries and can be used in a simple and practical way, it was predominantly developed and calibrated with types of oils that do not make up the loads currently used in refining, often favoring or disfavoring oils for OAC improperly, since some assumptions of the model have not been shown to be valid for current conditions. In addition, Heukelon does not consider the operational conditions and production routes of the Brazilian refining system, not allowing to extract operational reliability information. With the increased processing of pre-salt loads in refineries, it becomes necessary to have a more appropriate and updated framework for evaluating oils for OAC.

The difficulties and challenges imposed by the new available and increasingly processed oils in the Brazilian refining system, especially those from pre-salt fields, were the motivation for this invention. In OAC campaigns, such loads are mixed with different types of oils, in order to adjust the blend for production, requiring the evaluation of its suitability in accordance with the requirements of the ANP (National Agency of Oil, Natural Gas and Biofuels) considering the production route (RASF or VR) . In many cases, there is a loss of assertiveness in production, with consequent operational and commercial disruptions. In this way, the need arises for a method to enable the increase in operational reliability, allowing the choice of the probability of fitting the production in OAC campaigns.

Document PT2584381T discloses a method to predict the physicochemical properties of crude oils from T2 NMR assays (relaxation curve). This document uses a machine learning method based on a neural network model.

Document PI07168659A2 discloses a method to analyze geological data coupled to different phenomenological models to simulate oil reservoirs, predicting oil production profiles. It is an algorithm that initially samples historical models of reservoirs, generating a larger set of models, which, through the genetic algorithm, represent the reservoir. With this historical approximation, an approximate simulation of the production prediction is carried out, which, according to the description, requires less simulation time with more accurate results in relation to other systems of the same nature.

In the study by FERREIRA, F. A. (2013) “Analise do Dimensionamento de Pavimentos Asfalticos utilizando o Programa SisPavBR”, 110p., Graduation in Civil Engineering from the Polytechnic School, Federal University of Rio de Janeiro, describes a structure analysis tool of layered systems (pavements), coupled with performance models of paving materials, including soils, graded gravel, chemically stabilized materials and asphalt mixtures, among others. The document discloses a study on the empirical and mechanistic-empirical methods of dimensioning flexible pavements with the objective of comparing the dimensioning method of the program (SisPavBR) with the empirical method of DNIT and with the results obtained in other comparative studies that used computer mechanistic programs.

No document presented in this State of the Art discloses a method both from the point of view of organization and database processing, and about process mapping and solutions from machine learning such as this of the present invention. Also, for asphalts produced according to the Brazilian specifications regulated by the ANP, such as those modeled by the present invention, an empirical technique of the Heukelon abacus is widely used, as previously mentioned in this document.

Document PT2584381T discloses a method in which there is a need for a laboratory experiment, while the method of the present invention has a hierarchical logistic regression model using Bayesian methods for parameter estimation, and further, does not require any experimental analysis during its use, thanks to the Business Intelligence technique (BI) used to collect production data from refineries.

In document PI07168659A2, it is verified that the programming, the types of analyses and the data format, in addition to the purpose, differ from the present invention.

Document BR112019017897A2 discloses systems and methods for query and index optimization to retrieve data in cases of a database formulation data structure. However, such a document does not contain a database with specific anomaly detection algorithms, production routes and production difficulty, which allow the creation of the Bayesian logistic regression model of the system, such as the present invention.

The study by FERREIRA, F. A. (2013) discloses a tool that does not analyze asphalt or oil, which does not use data science, machine learning, among other analytical resources.

The present invention minimizes or solves the operational difficulties of the refining system when producing OAC, allowing the selection and/or optimization of oil lists that favor the product fitting, reducing OAC campaign times, ensuring its quality, and at the same time easing oil restrictions for the production of asphalt.

The method of the present invention uses specific algorithms to detect anomalies, production routes, and difficulties in producing asphalt and oil loads. The used database allows machine learning to generate a highly accurate (86%) probabilistic logistic regression model, developed for this purpose.

The present invention has advantages of making the allocation of oils more flexible; reduction of OAC campaign times and operating costs; greater reliability in asphalt production; and ease of use.

### BRIEF DESCRIPTION OF THE INVENTION

The present invention addresses to a method of evaluating lists of oils for the production of asphalts, which allows the fitting of the product, reducing OAC campaign times and ensuring its quality, at the same time easing oil restrictions for the asphalt production.

The invention can be applied in the Logistics field for purposes of refining planning and oil allocation; in the Refining area for the production of asphalt; in R&D (Research and Development) for the evaluation of oils and studies related to the development of products; and can be adapted by the digital transformation area to implement digital twins in refineries.

### BRIEF DESCRIPTION OF THE DRAWINGS

The present invention will be described in more detail below, with reference to the attached figures which, in a schematic and non-limiting way of the inventive scope, represent examples of its embodiment. In the drawings, there are:

FIG. 1 illustrating a block diagram of the components of the invention;

FIGS. 2 and 3 illustrating the development of the invention;

FIG. 4 illustrating the result of the invention;

FIG. 5 illustrating the CSI values of the industrial samples that are plotted versus penetration at 25° C., together with the limits for OAC 30/45;

FIG. 6 illustrating the penetration versus CSI space. Penetration at 25° C. versus CSI – illustration of Delta CSI calculation, with different examples;

FIG. 7 illustrating the probability of Yes versus Delta CSI for different samples;

FIG. 8 illustrating the probability of Yes versus Delta CSI with 75%, 85% and 95% one-tailed confidence intervals as indicated. The solid symbol refers to the average of Refinery 1, and the other symbols (transparent) refer to the other analyzed samples.

### DETAILED DESCRIPTION OF THE INVENTION

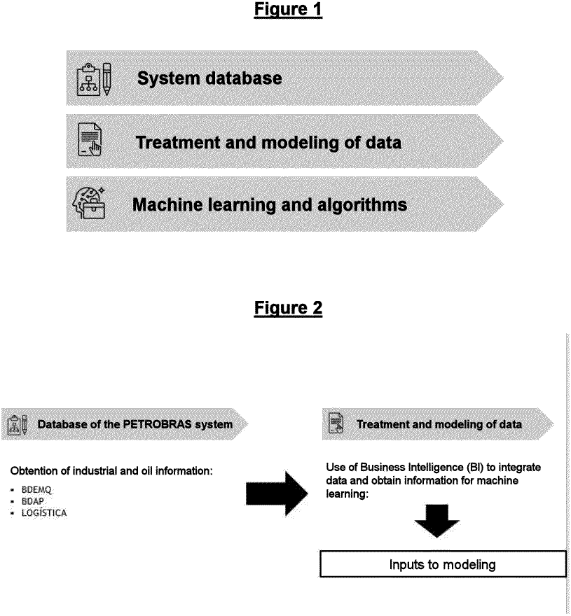

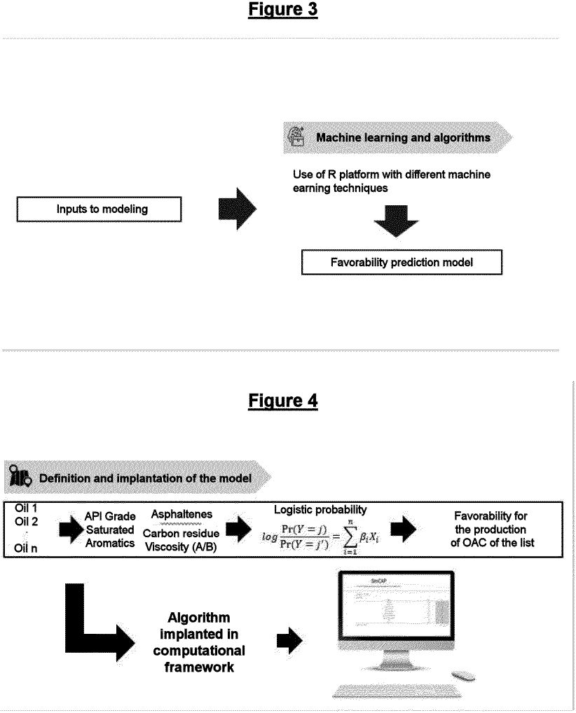

The method and result, according to the present invention and illustrated in FIGS. 1-4, comprises the following steps:

(i) Database for obtaining industrial and oil information (BDEMQ, BDAP, LOGÍSTICA) consisted of obtaining various industrial information on asphalt production using databases from the PETROBRAS system: from BDEMQ (Database of Storage, Handling and Quality) the compositions and volumes processed in the refineries, the production and storage of asphalts and results of laboratory analyses were obtained; from BDAP (Integrated Oil Evaluation Data System) the properties of the oils used in the OAC campaigns were determined and the LOGÍSTICA (Logistics Management Information System) was used to evaluate the pre-salt loads in the oil streams. Table 1 below shows the databases used:

TABLE I

Details of data sources used in this study

| | |
|---|---|
| Source | Obtained data |
| BDEMQ | Composition and volumes processed in the refinery: Table VW_CARGA_UNID_PROC_DET Production and storage (tanks) of asphalt: Table OPERATION and Table QUANT_DIA_LOG_OPER Laboratory Analysis: Table RESULTADO_ENSAIO and Table CARACT_PRODUTO |
| BDAP | Properties of the oil streams: API density, viscosity, among others, obtained by the database export tool |
| LOGÍSTICA | Percentage of pre-salt in the oil streams: Bulletin released by the Oil Supply Management (LOG/PR/ SP /AASP) |

(ii) Treatment and modeling of data through the use of a Business Intelligence type data analysis platform (Power BI) to integrate information and obtain information for machine learning, such as oil used in OAC campaigns, properties of oil lists, production and refining routes, product properties, indices for evaluating product fitting, and operational difficulties. Data processing allowed the evaluation of numerous OAC campaigns at PETROBRAS refineries, consolidating processed loads/oils, produced volumes, production routes and product quality/operational difficulties. In this last analysis, a query (subroutine) was created, which, given the product shipment flows to the tank, sampling and test results, made it possible to evaluate the difficulties (percentages of hits and errors) in campaigns for the production of asphalt, consolidating a base of around 35,000 lines with industrial information on OAC production. The mapping of shipments to refinery tanks was used as a strategy to identify OAC production routes. All shipments originating from a UDASF (Desasphalting Unit) were considered to be a RASF route (production of asphalt with asphalt waste from UFASF); starting from a UDAV (Vacuum Distillation Unit) and with no simultaneous sending of UDASF, the OAC production was considered by VR route (asphalt production with vacuum residue from the UDAV). In all routes, RASF or VR, the presence of diluents was also analyzed. To monitor the quality of the produced OAC, the viscosity and penetration values obtained at the mapped sampling points were collected and compared with the current specification, OAC 50170 or OAC 30/45, in order to attest to the fitting of the samples (or the respective campaign). In this study, only samples of finished products were considered, such as OAC 50/70 and OAC 30/45, which have a defined specification and allow evaluation of the fitting. An important concept introduced in this study was the percentage of failures in asphalt production, defined as the percentage fraction of the samples specified in viscosity and penetration in relation to the total samples. Within this context, a percentage of failures lower than 100% indicates that at least one sample was specified in terms of viscosity and penetration, and that that list of oils is favorable to the production of OAC in the route under analysis. The closer to zero the percentage is, the more favorable the list will be in the respective production route.

(iii) Machine learning and implementation of algorithms through the use of object-oriented functional programming language (using the R program), with different machine learning techniques, such as: Hierarchical Logistic Regression, Gaussian Processes, Neural Networks, Vectors supported by machines, and Random Forests. With the data in hand, the various machine learning techniques were tested in order to improve the predictive capacity of the tool. For this, the database was divided into a test set and a training set, and the performance of the models was compared according to the accuracy in these two sets. Table II shows a summary of the techniques used and the accuracy results of the models.

TABLE II

Machine learning techniques used in the analyses and accuracy of the models

| Model | Accuracy (Training) | Accuracy (Test) |
|---|---|---|
| Hierarchical Logistic Regression | 0.86 | 0.85 |
| Gaussian processes | 0.86 | 0.85 |
| Neural Networks | 0.86 | 0.85 |
| Vectors supported by machines | 0.86 | 0.84 |
| Random forests | 0.85 | 0.84 |

As can be noted, the different models have equivalent results in terms of accuracy. Based on the excellent training and test accuracies, and thinking about the application of the technique, it was decided to use the Hierarchical Logistic Regression model, because, in addition to having an efficiency equivalent to the other methods, the use of regularization and marginalization techniques inherent to Bayesian processes makes the algorithm more robust and reliable for use in extrapolations in relation to the original database.

Therefore, the generalized linear model was developed based on supervised machine learning, with logarithmic transformation of relative probabilities, as shown in Equation 1. It has favorabilities for OAC production calculated on probabilistic and categorical bases, considering the additive nature of the properties of oils and the propagation of the uncertainty.

$$l n \frac{Pr \left(Y - j\right)}{\text{Pr} \left(Y - {j}^{1}\right)} - {\sum }_{i = 1}^{n} {β}_{i} {Χ}_{i}$$

Where:
Pr (Y=j) = probability of yes (value between 0 and 1);
Pr (Y=j′) = probability of not (value between 0 and 1);
Pr (Y=j′) = 1 – Pr (Y=j);
Xi = property i of oil list (obtained by mass additivity based on composition);
βi = parameter or linear coefficient of the model for property i (obtained from supervised machine learning);
n = number of variables i.

With this, the model is defined based on machine learning, which selects the variables (oil properties - Xi) API grade, saturated, aromatics, asphaltenes insoluble in n-heptane, carbon residue, and the oil viscosity parameters A and B, for calculating the logarithmic probability of fitting or not fitting the OAC of a given list, according to Equations 2 and 3, according to the production route.

$$\begin{matrix}l n {\left(\frac{{P}_{S i m}}{{P}_{N \tilde{a} o}}\right)}_{l i s t} & = {\sum }_{i = 1}^{n} l n {\left(\frac{{P}_{S i m}}{{P}_{N \tilde{a} o}}\right)}_{i} ⋅\end{matrix} {p}_{i}$$

$$\begin{matrix}{P}_{S i m} = & \frac{{e}^{l n \left(\frac{{P}_{S i m}}{{P}_{N \tilde{a} o}}\right)} l i s t}{1 + {e}^{l n \left(\frac{{P}_{S i m}}{{P}_{N \tilde{a} o}}\right)} l i s t}\end{matrix}$$

Where:
n = quantity of oils i that make up the list;
pi = percentage quantity of each oil i in the mixture, which may be by mass or volume, depending on the analysis.

The model is implanted in a web application based on the R platform, and in an electronic spreadsheet (MS Excel), where it is possible to select the list and the production route. Based on this information, the probabilities of fitting and not fitting OAC in the campaign in question are calculated.

### Examples

The following examples are presented in order to more fully illustrate the nature of the present invention and the way to practice it, without, however, being considered as limiting its content.

The method of this invention was recently used and validated in the production of asphalt at Refinery 1 (PETROBRAS). This refinery was used as a reference because it was showing marginality in the production of asphalt, with difficulties in fitting it and successive complaints from customers. With the present invention and a parameter that measures the marginality of the produced OAC (Delta CSI –Critical Susceptibility Index), a strong correlation was verified between the marginality of the OAC production and the favorability of the processed lists. Such a validation allowed the definition of the minimum favorability limits determined by the method of the invention for different levels of production reliability, as described below in more detail.

OAC 30/45 from Refinery 1 has been produced with border penetration values at 25° C. and Brookfield rotational viscosity at 177° C. This fact often causes problems for the refinery with the customers, since marginal specification values can be measured as being outside the limits, during the technological control of the paving works, given the variability of such tests, thus compromising the delivery of the product and generating inconvenience and industrial costs.

In view of the challenges faced by Refinery 1 for the production of OAC 30/45, there have been used industrial data on the marginal values of penetration of OAC 30/45 in shipments made in the months of April, May and June 2021 for diagnosis of deviations and validation of the model object of this invention.

In order to represent the criticality of OAC 30/45 production in Refinery 1, using penetration data at 25° C. and Brookfield viscosity at 177° C., the Critical Susceptibility Index (CSI) of the monitored samples was calculated, as defined in equation 4.

$$C S I = - 1. \left\{l o g \left(\frac{V i s c 177 ° C}{100}\right) - \left[4 + l o g \left(800\right) - l o g \left(P e n 25 ° C\right)\right]\right\}$$

Where:
Visc177° C. = Brookfield viscosity at 177° C., cP; and
Pen25° C. = Penetration at 25° C., × 0.1 mm.

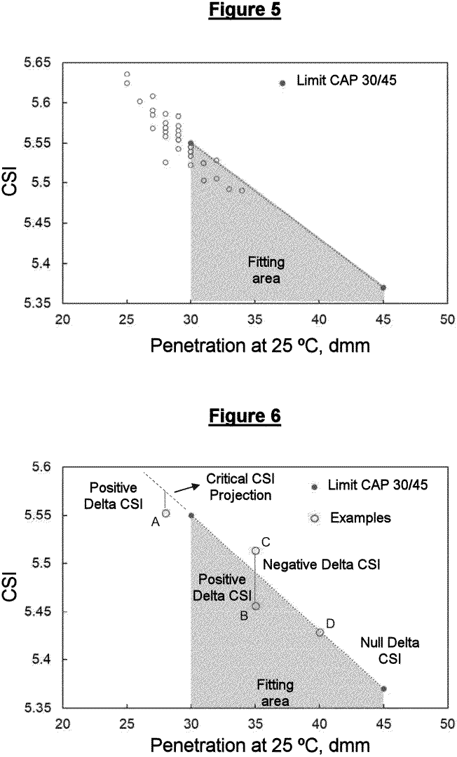

The CSI is an OAC susceptibility parameter that relates penetration to viscosity at 177° C., using the scale of the Heukelon diagram. The higher its value, the more critical the penetration-viscosity pair is for the product to comply with the ANP specification. In FIG. 5, the CSI values of the industrial samples are plotted versus penetration at 25° C., along with the limits for OAC 30/45.

Upon observing FIG. 5, it is noticed that many OAC 30/45 samples are outside the fitting area. Even though a good part of the samples is not fit due to the non-compliance with the minimum penetration limit, it is verified that the CSI values are very high, frequently above the border line when considering its projection for penetration values lower than 30 × 0.1 mm, possibly indicating bottlenecks related to the lists of oils used as load in OAC campaigns.

The next step of the analysis consisted of evaluating the favorability (use of the model of this invention) of the oil lists used in the period from April to June 2021. The campaigns of the period were divided into two categories: (i) General and (ii) OAC, whose average favorability results are shown in Table III.

TABLE III

Average favorabilities determined by the model for the production of OAC, of the oil lists used as load in Refinery 1 - April to June 2021

| Campaign Category | Averaged Probability of Yes | Standard Deviation of Average | Minimum Probability of Yes | Maximum Probability | Averaged Delta CSI |
|---|---|---|---|---|---|
| General | 0.51 | 0.02 | 0.48 | 0.59 | – |
| OAC | 0.64 | 0.04 | 0.59 | 0.69 | 0.0084 |

In Table III, it is possible to verify that Refinery 1 used significantly more favorable loads in OAC campaigns, with an average Yes favorability of 0.64, minimum value of 0.59 and maximum value of 0.69. In this sense, it is necessary to verify whether such favorability values are adequate and, if not, which would be the minimum favorability values recommended for OAC 30/45 campaigns at Refinery 1.

To evaluate the suitability of the oil favorability indices in OAC campaigns, the value of Delta CSI was defined as an indicator of OAC production gap. The Delta CSI is the vertical distance between the critical or border CSI (according to ANP specification) and the CSI of the OAC under analysis, in the penetration versus CSI space, as shown in FIG. 6.

It is worth to highlight, in FIG. 6, that even an OAC with penetration beyond the limit established by the ANP specification, it may have a positive Delta CSI as long as it has rotational viscosity at 177° C. suitable for the condition in question (A). Example C has negative Delta CSI, even with the penetration within the specified value, indicating that it is a sample with low viscosity. In Table III, it is verified that the average Delta CSI of the analyzed OAC 30/45 samples is 0.0084; that is, slightly positive, indicating the average marginality of OAC production in the refinery when considering such a production period.

Some samples of industrial OACs, from previous years, and even laboratory VRs, were selected for calibration of the ideal probability of Yes of work in the refinery, in order to provide greater production gaps by improving oil planning (definition of criterium for implementing the methodology object of this invention). Such samples, their properties and the Yes probability of their respective lists are shown in Table IV. It is worth mentioning, with regard to the samples in the table, that all those from Refinery 1 are from typical campaigns monitored from 2016 to 2018, the same being true for the samples from Refinery 2 and Refinery 3. To compose the group in order to obtain a wide range of favorability, VRs were used with large quantities of Pre-Salt, coming from the CENPES laboratory (Petrobras) and from Refinery 4 (specific OAC campaigns).

TABLE IV

Properties of the OAC samples used in the model calibration for Refinery 1

| Origin | Yes probability of the list | Penetration at 25° C., × 0.1 mm | Brookfield Viscosity 177° C., cP | Delta CSI |
|---|---|---|---|---|
| Refinery 1 | 0.81 | 32 | 80.6 | 0.034 |
| Refinery 1 | 0.63 | 33 | 78.2 | 0.023 |
| Refinery 1 | 0.73 | 30 | 78.3 | 0.018 |
| Refinery 1 | 0.79 | 31 | 86.7 | 0.064 |
| Refinery 1 | 0.69 | 34 | 73.5 | - 0.003 |
| Refinery 1 | 0.63 | 33 | 73.2 | - 0.006 |
| VR/Laboratory | 0.64 | 43 | 73.1 | - 0.012 |
| Refinery 2 | 0.90 | 52 | 71.8 | 0.104 |
| Refinery 2 | 0.91 | 57 | 64.6 | 0.061 |
| VR/Laboratory | 0.44 | 61 | 44.0 | - 0.107 |
| VR/Laboratory | 0.50 | 60 | 44.3 | - 0.104 |
| Refinery 3 | 0.42 | 58 | 48.0 | - 0.068 |
| Refinery 4 | 0.56 | 53 | 59.3 | 0.022 |

In FIG. 7, the values of probability of Yes of the model versus Delta CSI are plotted, where a strong correlation between these properties is observed. That is, the more favorable the list of oils is for OAC production (according to the model object of the invention), the greater the gap to obtain or fit the product. Furthermore, it appears that the trends observed for samples of different natures are similar, corroborating the robustness of the proposed model and its applicability in the oil planning system for asphalt production.

It is worth remembering that a positive Delta CSI indicates that the product fits into critical properties, which happens to occur with probabilities of 0.66, deterministically, according to the linear regression in FIG. 7. It can be noted that the lists of oils used in Refinery 1 in the older samples showed favorabilities in the 0.63 – 0.81 range and followed the trend of greater production gaps with increasing favorability. For example, one of the samples, with high favorability (0.79), processed in Refinery 1, presented a Delta CSI of 0.064, while the sample with the lowest favorability of the refinery, with a value of 0.63, presented a Delta CSI of -0.006; that is, it did not fit.

According to data from industrial samples, the average favorability of the lists of Refinery 1 in 2021 was 0.64 with an average Delta CSI of 0.008. It is a favorability value similar to the threshold (between negative and positive Delta CSI) shown in FIG. 7, with practically zero average Delta CSI, validating, in industrial practice, the value found by the regression. In other words, there is observed a favorability of marginal lists with practically zero Delta CSI and marginal products, according to industrial data.

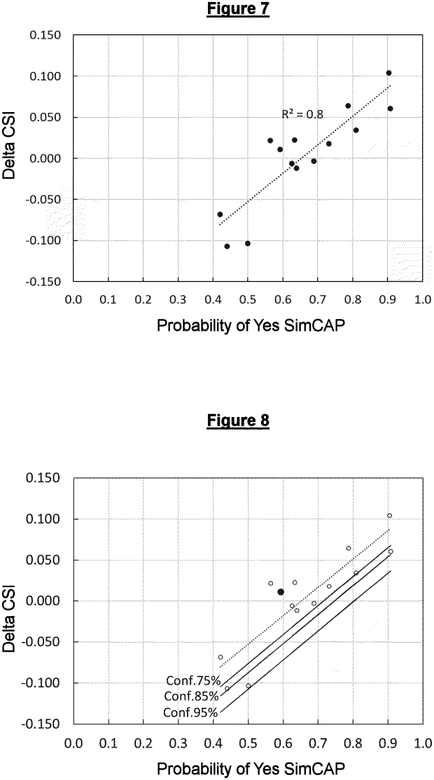

In the allocation of oils, the eventual use of list favorability, in VR route, especially in Refinery 1, in the value of 0.66, as it is a deterministic threshold, indicates that the chances of fitting the product are 50%. The probabilities of obtaining OAC with positive or negative Delta CSI are the same. In view of this observation, the minimum favorability thresholds were determined for Refinery 1, considering the standard error of the prediction obtained for the data in Table IV, with one-tailed confidence intervals of 75%, 85% and 95%, according to distribution of Student (number of samples less than 30), as shown in FIG. 8.

From FIG. 8, it was possible to determine the minimum values of probability of Yes of the model for the different confidence intervals, aiming at the production of OAC, which are presented in Table V.

As a development, the data in Table V are used as a reference for the allocation of oil in the refinery, and the methodology after being implemented resulted in greater flexibility in the allocation of oil and greater assertiveness in asphalt campaigns (there was no production failure in this period). The months from September to April 2021 were monitored (after using the methodology in the allocation of oils), where it was verified that the assumptions and calibrations presented here are valid. Currently, the use of the methodology is being expanded for use in other refineries in the Petrobras system.

TABLE V

Values of minimum probability of Yes of the model, for different confidence intervals of OAC campaigns in VR route -Refinery 1

| Confidence level, % | Minimum probability of Yes |
|---|---|
| 50 | 0.66 |
| 75 | 0.71 |
| 85 | 0.74 |
| 95 | 0.80 |

In addition to the use of the method of this invention in the allocation of oils, some Petrobras refineries are testing the method during the production of OAC campaigns. It is worth noting that the refineries that operate with the greatest operational gaps for OAC production, when their OAC campaign lists are analyzed using the method of the invention, show high favorability

Accordingly, both the results of studies and industrial monitoring presented here and the statistical data of the model corroborate the good results obtained for the invention in question.

It should be noted that, although the present invention has been described in relation to the attached drawings, it may undergo modifications and adaptations by technicians skilled on the subject, depending on the specific situation, but provided that it is within the inventive scope defined herein.

1. A METHOD FOR EVALUATION OF OIL LISTS FOR ASPHALT PRODUCTION, characterized in that it comprises the following steps:
(i) Database for obtaining industrial and oil information;
(ii) Treatment and modeling of data through the use of Business Intelligence (Power BI) to integrate data and obtain information for machine learning;
(iii) Machine learning and implementation of algorithms through the use of the R platform with different machine learning techniques, which selects the variables for calculating the logarithmic probability of fitting or not fitting OAC of a given list.

2. THE METHOD FOR EVALUATION OF OIL LISTS FOR ASPHALT PRODUCTION according to claim 1, characterized in that the industrial and oil information of step (i) are taken from the following databases: BDEMQ – to obtain the compositions and the volumes processed in the refineries, the production and storage of asphalts, and the results of laboratory analyses, BDAP – to determine the properties of the oils used in the OAC campaigns, and LOGÍSTICA - to evaluate the pre-salt loads in the oil streams.

3. THE METHOD FOR EVALUATION OF OIL LISTS FOR ASPHALT PRODUCTION according to claim 1, characterized in that the information obtained for the machine learning of step (ii) are oils used in OAC campaigns, properties of the oil lists, routes of production and refining, product properties, indices for evaluating product fit, and operational difficulties.

4. THE METHOD FOR EVALUATION OF OIL LISTS FOR ASPHALT PRODUCTION according to claim 1, characterized in that the machine learning techniques of step (iii) are chosen among Hierarchical Logistic Regression, Gaussian Processes, Neural Networks, Vectors Supported by Machines, and Random Forests.

5. THE METHOD FOR EVALUATION OF OIL LISTS FOR ASPHALT PRODUCTION according to claim 1, characterized in that the variables selected in step (iii) are API grade, saturated, aromatics, asphaltenes insoluble in n-heptane, carbon residue and the oil viscosity parameters A and B.

6. THE METHOD FOR EVALUATION OF OIL LISTS FOR ASPHALT PRODUCTION according to claim 1, characterized in that, in step (iii), the model is implanted in a web application, based on the R platform, and also in an electronic spreadsheet, to select the list and production route and calculate the probabilities of fitting and not fitting OAC in the OAC production campaign.
